(19) United States
(12) Patent Application Publication
(10) Pub. No.: US 2010/0092238 A1
(43) Pub. Date: Apr. 15, 2010

(54) ACTIVE MATERIAL ELEMENTS HAVING REINFORCED STRUCTURAL CONNECTORS

(75) Inventors: PABLO D. ZAVATTIERI, ANN ARBOR, MI (US); XIUJIE GAO, TROY, MI (US); WILLIAM B. CARTER, VENTURA, CA (US); ELENA SHERMAN, CULVER CITY, CA (US); ALAN L. BROWNE, GROSSE POINTE, MI (US); NANCY L. JOHNSON, NORTHVILLE, MI (US); PAUL W. ALEXANDER, YPSILANTI, MI (US); NILESH D. MANKAME, ANN ARBOR, MI (US); WILLIAM R. RODGERS, WARREN, MI (US); ROBIN STEVENSON, WARREN, MI (US); JAMES H. SHOEMAKER, WHITE LAKE, MI (US)

Correspondence Address: SLJ, LLC, 324 E. 11th St., Ste. 101, Kansas City, MO, 64106, US

(73) Assignee: GM GLOBAL TECHNOLOGY OPERATIONS, INC., DETROIT, MI (US)

(21) Appl. No.: 12/250,148

(22) Filed: Oct. 13, 2008

(51) Int. Cl. F16G 11/02

(52) U.S. Cl. 403/274

(57) ABSTRACT

An active material assembly for interconnecting with at least one structural member of a structure, sustaining a load over a predetermined period, and selectively effecting a change in the structure, includes at least one active material element, such as a shape memory wire, and a reinforcing connector, such as a ring terminal crimp fixedly secured to the wire, and more preferably including the use of one or more tube or shim intermediate the wire and crimp, wave form imparting configurations, collets, or ferrules.

### BACKGROUND

The present invention relates to structural connectors and methods of reinforcing connection between structural members, and more particularly, to structural connectors adapted for use with and methods of interconnecting a structural member comprising an shape memory wire.

Active material elements are conventionally utilized to effect reconfiguration and/or bias variance in structural assemblies, actuators or smart devices, when activated or deactivated. For example, shape memory alloy (SMA) wires are often used to transfer loads between and cause the displacements of structural members, upon activation. That is to say, once thermally activated, the crystal structure of the alloy reconfigures and in turn causes the wire to shrink; the actuating or reconfiguring force is transferred to the coupled members solely through their connection points. In promoting this function, it is appreciated that secure methods of joining (e.g., “connecting”) these wires to the structural members play a vital role.

Among conventional methods of joining, mechanical crimping is the most widely used method. This method, however, presents various concerns in the art. For example, failure, such as wire slipping or fatigue at or adjacent the crimp is a commonly experienced mal condition. Such failure, in turn, may cause the collapse of the assembly or early malfunction of the actuator or smart device. Of further conventional concern, the need to provide an isolated electrical connection to the wire is often made more complex by the addition of these crimps.

Thus, for these reasons and more, there remains a need in the art for an improved method of joining active material elements, such as a shape memory wire, to structural members that increases structural capacity, reduces the likelihood of premature failure, and enables isolated electrical connection where needed.

### BRIEF SUMMARY

The present invention concerns plural embodiments of an assembly (e.g., “link”) for and method of joining an active material element to structural members that addresses the afore-mentioned concerns. The inventive assembly is robust enough to avoid failure, while providing a cost effective and readily implemented solution. In general, the invention utilizes a reinforcing connector attached to the active material element, and various connector/element configurations that cooperatively increase the capacity of the structure.

It is an object of the invention to provide an active assembly, adapted for use in a structure including at least one structural member. In addition to being able to effect a reconfiguration of or biasing force in the structure, the assembly is capable of sustaining a load over a predetermined period not previously sustainable by the prior art.

The assembly generally includes at least one element formed at least in part of an active material operable to change a first condition in response to an activation signal; and at least one reinforcing connector securely fixed to the element. The connector presents an interconnecting portion configured to enable interconnection between the active assembly and said at least one member.

Other aspects and advantages of the present invention, including the employment of at least one shape memory allow wire as the active material element, and connectors comprising ring terminals, metal tubing/shims, and other configurations will be apparent from the following detailed description of the preferred embodiment(s) and the accompanying drawing figures.

### BRIEF DESCRIPTION OF THE DRAWINGS

A preferred embodiment(s) of the invention is described in detail below with reference to the attached drawing figures, wherein:

FIG. 1 is an elevational view of a structure including a plurality of members, an active material assembly including a shape memory wire and reinforcing connector, in accordance with a preferred embodiment of the invention;

FIG. 1a is an elevational view of the structure shown in FIG. 1, wherein the active material element has been activated by an activation signal source coupled to the assembly, and the structure reconfigured as a result thereof;

FIG. 2 is a perspective view of a ring terminal crimp flattened about a distal end of an active material element (e.g., a shape memory wire), in accordance with a preferred embodiment of the invention;

FIG. 3 is a perspective view of a metal tube flattened about distal ends of a plurality of shape memory wires, in accordance with a preferred embodiment of the invention;

FIG. 4 is an elevation view of a plurality of shape memory wires inserted within a plurality of individual metal tubes inserted within a metal crimp flattened about the pluralities of wires and individual metal tubes, in accordance with a preferred embodiment of the invention;

FIG. 4a is a perspective view of the assembly shown in FIG. 4, wherein portions of the pluralities of wires and individual tubes protruding from the crimp are bent back so as to form catches with the outer wall thereof, in accordance with a preferred embodiment of the invention;

FIG. 5 is an elevation view of a plurality of shape memory wires sandwiched between first and second metal shims inserted within a crimp flattened about the pluralities of wires and shims, in accordance with a preferred embodiment of the invention;

FIG. 5a is a side elevation view of the assembly shown in FIG. 5, particularly illustrating the wires and shims;

FIG. 6 is an elevation view of a plurality of n shape memory wires bent over and passed through first and second connectors, such that a plurality of 2n wire segments extend within and are crimped by each connector, so as to form opposite ellipsoidal loops, in accordance with a preferred embodiment of the invention;

FIG. 7 is an elevation view of a plurality of shape memory wires inserted within an interior tube that is flattened, folded over and then inserted within a ring terminal that is also flattened, in accordance with a preferred embodiment of the invention;

FIG. 8 is an elevational view of a plurality of shape memory wires inserted within an interior tube that is flattened adjacent its distal ends, and bent, so as to define an ellipsoidal middle section, and then inserted within an exterior tube, which is also flattened, in accordance with a preferred embodiment of the invention;

FIG. 9 is an elevation view of a plurality of shape memory wires inserted within a plurality of individual metal tubes inserted within an exterior metal tube flattened about the pluralities of wires and individual metal tubes, wherein the exterior metal tube defines a concavity configured to produce a wave form in the wires and individual tubes when the exterior tube is flattened, in accordance with a preferred embodiment of the invention;

FIG. 9a is an elevation view of the assembly shown in FIG. 9, particularly illustrating the concavity;

FIG. 10 is an elevation view of an shape memory wire inserted within a connector comprising a collet and first and second cones of softer material, in accordance with a preferred embodiment of the invention;

FIG. 10a is a cross-section of the assembly shown in FIG. 10, particularly illustrating the sloped internal surfaces;

FIG. 11 is a side elevational view of an shape memory wire inserted within a collet connector comprising a slotted inner wedge, in accordance with a preferred embodiment of the invention;

FIG. 12 is an elevational view of an shape memory wire inserted within a connector comprising first and second off-centered gears configured to increasingly engage the wire as it is pulled relative thereto, in accordance with a preferred embodiment of the invention;

FIG. 13 is an elevational view of an shape memory wire inserted within a connector comprising an inner frame defining flexible arms and a clamping shoe for increasingly engaging the wire as it is pulled relative thereto, in accordance with a preferred embodiment of the invention;

FIG. 13a is an elevational view of the assembly shown in FIG. 13, wherein the shoe is translated, the arms are flexed, and the engagement force between the shoe and wire is increased, as a result of wire displacement;

FIG. 14 is a cross-section of a plurality of shape memory wires sandwiched between the outer tube and inner rod of a connector, wherein the inner rod is first cooled and inserted within the outer tube, in accordance with a preferred embodiment of the invention;

FIG. 15 is an elevation of an shape memory wire and connector, particularly illustrating variable compressive force along the longitudinal axis of the wire and a compliant element at a distal end of the connector, in accordance with a preferred embodiment of the invention;

FIG. 16 is a cross-section of a crimp defining a space, and a shape memory wire extending within the space and defining a knot, in accordance with a preferred embodiment of the invention; and

FIG. 17 is an elevation of an shape memory wire and connector including a ferrule, in accordance with a preferred embodiment of the invention.

### DETAILED DESCRIPTION

The present disclosure concerns a structure 10 comprising at least one structural member 12 and an inventive active material assembly 14 that forms a link or joint in the structure 10. As used herein the term “structure” shall mean an interconnected multi-part embodiment whose function includes generating, transferring or sustaining a load across the link, and shall include active material actuators and smart devices. The inventive assembly 14 is generally configured to increase the structural capacity of the joints cooperatively formed with adjacent members 12, and to that end, includes at least one reinforcing connector 16. The connector 16 is configured to withstand a predetermined load over a period without failure. As such, the connector 16 is formed of material having sufficient tensile strength (e.g., aluminum) to sustain the load.

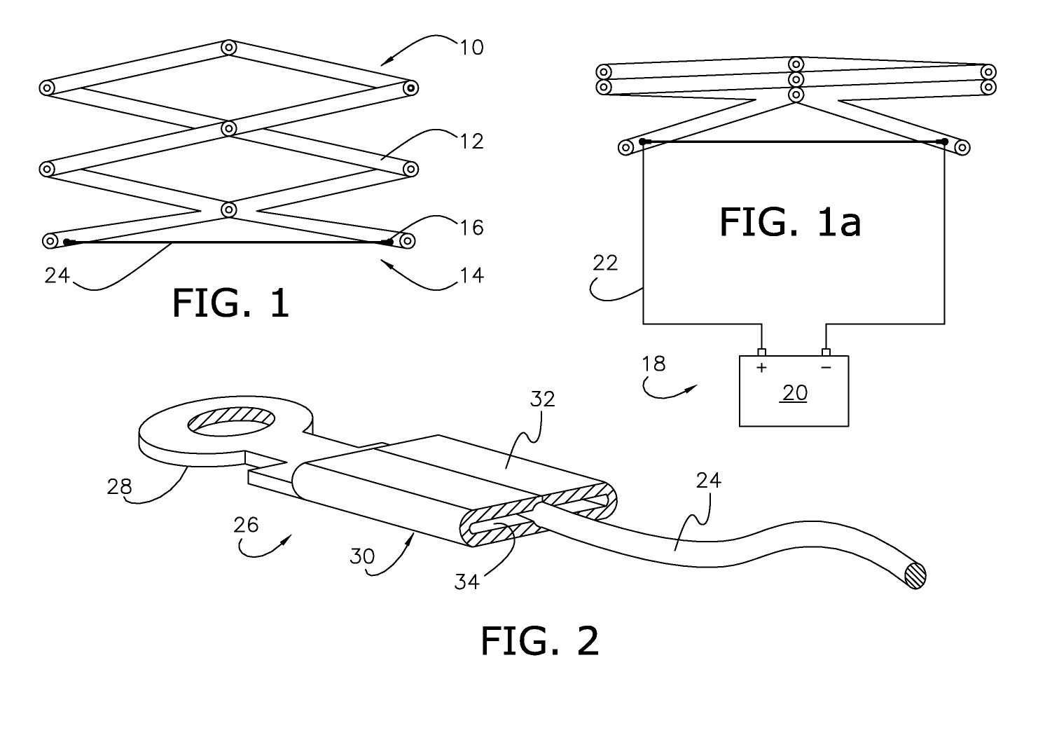

FIGS. 1 and 1a, for example, shows a conventional scissor lift structure 10 having a fixed and free end, and comprising a plurality of members 12 pivotably connected at their ends and midpoints. The lift 10 incorporates an active material assembly (e.g., “actuator”) 14 configured to cause the upper end to collapse and descend upon activation. In such structures, it is appreciated that where latching is not provided a tensile load is experienced across the link, even after reconfiguration. An activation signal source 18 is operably coupled to the actuator 14 and configured to selectively (e.g., manually or in response to sensory technology) generate an activation signal. As appreciated by those of ordinary skill in the art, the activation signal may be thermal, magnetic, electrical, chemical, and/or other like activation signal or a combination of activation signals. The source 18 in FIG. 1, for example, includes a battery 20, such as comprising the charging system of a vehicle (not shown), that is controllably coupled to the actuator 14 through conductive leads 22.

More particularly, the source 18 is coupled to an active material element 24 comprising the assembly or actuator 14, and may be directly or indirectly operable. With respect to the later, and as shown in FIG. 1, the leads 22 preferably engage the actuator 14 at the distal connectors 16, so as to deliver an electric current through the resistance of the element 24. This in turns generates a thermal activation signal. As such, the inventive connector 16 is preferably configured to electrically isolate the element 24 from the remainder of the assembly 14.

In response to the activation signal, the active material element 24 changes at least one attribute of the structure 10, and preferably reverts back to the original state of the at least one attribute upon discontinuation of the signal; or, for the classes of active materials that do not automatically revert upon discontinuation of the activation signal, alternative means can be employed to revert the active material to its original state as will be discussed in detail herein.

1. Active Material Description and Function

As used herein the term “active material” shall be afforded its ordinary meaning as understood by those of ordinary skill in the art, and includes any material or composite that exhibits a reversible change in a fundamental (e.g., chemical or intrinsic physical) property, when exposed to an external signal source. Thus, active materials shall include those compositions that can exhibit a change in stiffness properties, shape and/or dimensions in response to the activation signal, which can take the type for different active materials, of electrical, magnetic, thermal and like fields.

Preferred active materials for use with the present invention include but are not limited to the classes of shape memory materials, and combinations thereof. Shape memory materials generally refer to materials or compositions that have the ability to remember their original at least one attribute such as shape, which can subsequently be recalled by applying an external stimulus, as will be discussed in detail herein. As such, deformation from the original shape is a temporary condition. In this manner, shape memory materials can change to the trained shape in response to an activation signal. Exemplary shape memory materials include shape memory alloys (SMA), shape memory polymers (SMP), shape memory ceramics, electroactive polymers (EAP), ferromagnetic SMAs, dielectric elastomers, ionic polymer metal composites (IPMC), piezoelectric polymers, piezoelectric ceramics, various combinations of the foregoing materials, and the like.

Shape memory alloys (SMA's) generally refer to a group of metallic materials that demonstrate the ability to return to some previously defined shape or size when subjected to an appropriate thermal stimulus. Shape memory alloys are capable of undergoing phase transitions in which their yield strength, stiffness, dimension and/or shape are altered as a function of temperature. The term “yield strength” refers to the stress at which a material exhibits a specified deviation from proportionality of stress and strain. Generally, in the low temperature, or martensite phase, shape memory alloys can be plastically deformed and upon exposure to some higher temperature will transform to an austenite phase, or parent phase, returning to their shape prior to the deformation. Materials that exhibit this shape memory effect only upon heating are referred to as having one-way shape memory. Those materials that also exhibit shape memory upon re-cooling are referred to as having two-way shape memory behavior.

Shape memory alloys exist in several different temperature-dependent phases. The most commonly utilized of these phases are the so-called martensite and austenite phases discussed above. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (Aₛ). The temperature at which this phenomenon is complete is called the austenite finish temperature (A_{f}). When the shape memory alloy is in the austenite phase and is cooled, it begins to change into the martensite phase, and the temperature at which this phenomenon starts is referred to as the martensite start temperature (Mₛ). The temperature at which austenite finishes transforming to martensite is called the martensite finish temperature (M_{f}). Generally, the shape memory alloys are softer and more easily deformable in their martensitic phase and are harder, stiffer, and/or more rigid in the austenitic phase. In view of the foregoing, a suitable activation signal for use with shape memory alloys is a thermal activation signal having a magnitude to cause transformations between the martensite and austenite phases.

Shape memory alloys can exhibit a one-way shape memory effect, an intrinsic two-way effect, or an extrinsic two-way shape memory effect depending on the alloy composition and processing history. Annealed shape memory alloys typically only exhibit the one-way shape memory effect. Sufficient heating subsequent to low-temperature deformation of the shape memory material will induce the martensite to austenite type transition, and the material will recover the original, annealed shape. Hence, one-way shape memory effects are only observed upon heating. Active materials comprising shape memory alloy compositions that exhibit one-way memory effects do not automatically reform, and will likely require an external mechanical force to reform the shape that was previously suitable for airflow control.

Intrinsic and extrinsic two-way shape memory materials are characterized by a shape transition both upon heating from the martensite phase to the austenite phase, as well as an additional shape transition upon cooling from the austenite phase back to the martensite phase. Active materials that exhibit an intrinsic shape memory effect are fabricated from a shape memory alloy composition that will cause the active materials to automatically reform themselves as a result of the above noted phase transformations. Intrinsic two-way shape memory behavior must be induced in the shape memory material through processing. Such procedures include extreme deformation of the material while in the martensite phase, heating-cooling under constraint or load, or surface modification such as laser annealing, polishing, or shot-peening. Once the material has been trained to exhibit the two-way shape memory effect, the shape change between the low and high temperature states is generally reversible and persists through a high number of thermal cycles. In contrast, active materials that exhibit the extrinsic two-way shape memory effects are composite or multi-component materials that combine a shape memory alloy composition that exhibits a one-way effect with another element that provides a restoring force to reform the original shape.

The temperature at which the shape memory alloy remembers its high temperature form when heated can be adjusted by slight changes in the composition of the alloy and through heat treatment. In nickel-titanium shape memory alloys, for instance, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing the airflow control devices with shape memory effects, superelastic effects, and high damping capacity.

Suitable shape memory alloy materials include, without limitation, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-platinum based alloys, iron-palladium based alloys, and the like. The alloys can be binary, ternary, or any higher order so long as the alloy composition exhibits a shape memory effect, e.g., change in shape orientation, damping capacity, and the like. For example, a nickel-titanium based alloy is commercially available under the trademark NITINOL from Shape Memory Applications, Inc.

Shape memory polymers (SMP's) are known in the art and generally refer to a group of polymeric materials that demonstrate the ability to return to some previously defined shape when subjected to an appropriate thermal stimulus. Shape memory polymers are capable of undergoing phase transitions in which their shape is altered as a function of temperature. Generally, SMP's have two main segments, a hard segment and a soft segment. The previously defined or permanent shape can be set by melting or processing the polymer at a temperature higher than the highest thermal transition followed by cooling below that thermal transition temperature. The highest thermal transition is usually the glass transition temperature (T_{g}) or melting point of the hard segment. A temporary shape can be set by heating the material to a temperature higher than the T_{g} or the transition temperature of the soft segment, but lower than the T_{g} or melting point of the hard segment. The temporary shape is set while processing the material at the transition temperature of the soft segment followed by cooling to fix the shape. The material can be reverted back to the permanent shape by heating the material above the transition temperature of the soft segment.

The temperature needed for permanent shape recovery can be set at any temperature between about −63° C. and about 120° C. or above. Engineering the composition and structure of the polymer itself can allow for the choice of a particular temperature for a desired application. A preferred temperature for shape recovery is greater than or equal to about −30° C., more preferably greater than or equal to about 0° C., and most preferably a temperature greater than or equal to about 50° C. Also, a preferred temperature for shape recovery is less than or equal to about 120° C., and most preferably less than or equal to about 120° C. and greater than or equal to about 80° C.

Suitable shape memory polymers include thermoplastics, thermosets, interpenetrating networks, semi-interpenetrating networks, or mixed networks. The polymers can be a single polymer or a blend of polymers. The polymers can be linear or branched thermoplastic elastomers with side chains or dendritic structural elements. Suitable polymer components to form a shape memory polymer include, but are not limited to, polyphosphazenes, poly(vinyl alcohols), polyamides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, and copolymers thereof. Examples of suitable polyacrylates include poly(methyl methacrylate), poly(ethyl methacrylate), ply(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecyl acrylate). Examples of other suitable polymers include polystyrene, polypropylene, polyvinyl phenol, polyvinylpyrrolidone, chlorinated polybutylene, poly(octadecyl vinyl ether) ethylene vinyl acetate, polyethylene, poly(ethylene oxide)-poly(ethylene terephthalate), polyethylene/nylon (graft copolymer), polycaprolactones-polyamide (block copolymer), poly(caprolactone) dimethacrylate-n-butyl acrylate, poly(norbornyl-polyhedral oligomeric silsequioxane), polyvinylchloride, urethane/butadiene copolymers, polyurethane block copolymers, styrene-butadiene-styrene block copolymers, and the like.

H. Exemplary Systems and Methods

Referring now to FIGS. 2 through 16, the illustrated embodiments of the assembly 14 teach the various aspects and benefits of the present invention, and are more particularly described as follows:

In FIG. 2, the reinforcing connector 16 is presented by a flattened ring terminal crimp 26, such as the type used with battery cable terminals, large car audio system power feed wires, and welding cables. A crimp 26 is fixedly attached to each distal end of an active material element 24 (FIG. 1) presenting a wire configuration. It is certainly within the ambit of the invention, however, to use other configurations, such as braids, strips, strands, and cables with the inventive connectors 16, and as such, it is appreciated that the term “wire” shall include the afore-mentioned other configurations. The crimp 26 may be attached by using a hand tool, terminal crimping tool, hydraulic press, or other means.

The crimp 26 includes a fastening section 28 configured to facilitate removable interconnection (i.e., facile or manual connection and disconnection) between the active material assembly 14 and adjacent structural members 12. More particularly, in this configuration, a flat “O”-shaped section 28 is provided and configured to receive a fastener (not shown), as is known in the art. Opposite the fastening section 28, the crimp 26 presents an engaging section 30, which consists essentially of two wings 32 that are folded over when “crimped,” so as to define an interior connector space 34 and compress a distal section of the wire 24 extending within the space 34. As is known in the art, the crimp 26 adds mechanical strength and stress relief to the active material wire 24. It can also be made of insulative materials, so as to provide electrical isolation from nearby metal surfaces. As shown in the plural illustrations, the crimps 26 may interconnect one or more wires, as desired.

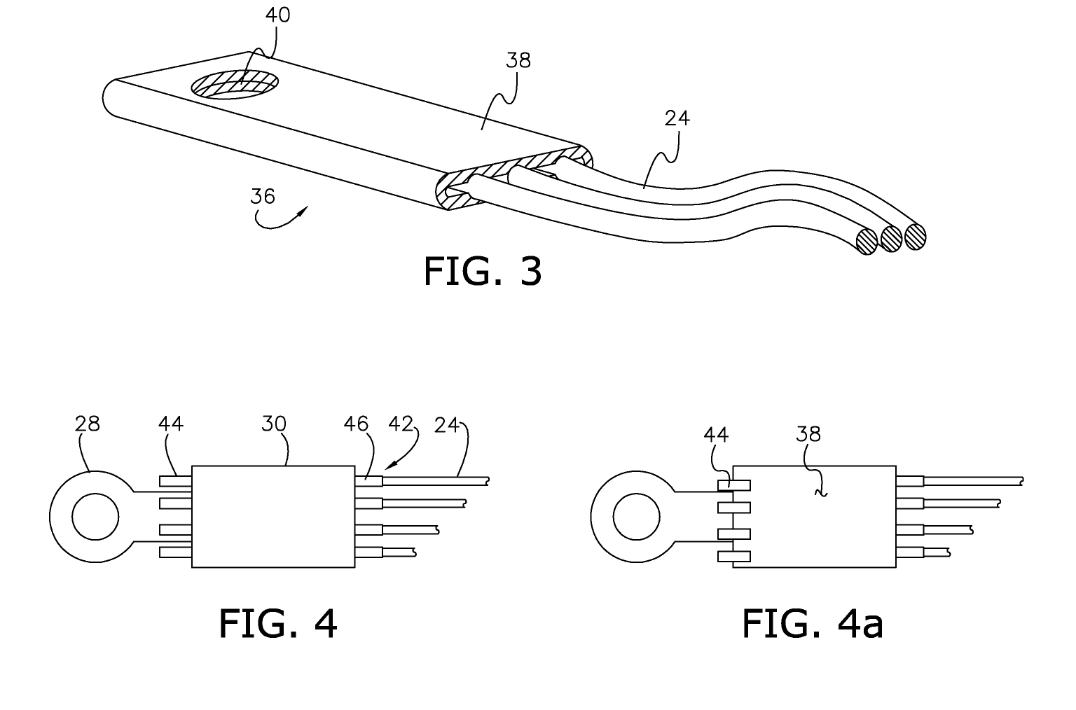

In FIG. 3, the connector 16 presents a singular metal tube 36 that is similarly flattened about a distal end section of the wire 24, and more preferably, is flattened along the entire length of the tube 36. The tube 36 presents a continuous outer wall 38 that defines the interior space 34; as used hereinafter, however, the term “outer wall” shall include the enclosed wall defined in part by the wings 32 of a crimp 26. The fastening section 28 is provided opposite the space 34 and includes a defined through-hole 40 for receiving a fastener.

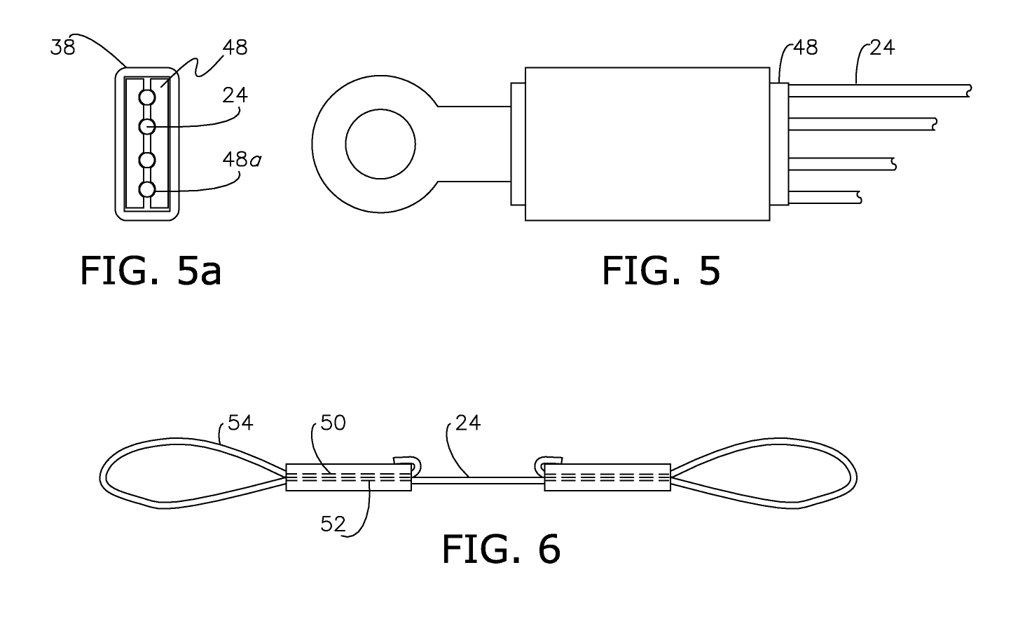

FIGS. 4-5 illustrate two methods of improving the frictional hold strength formed between the connector 16 and wire 24. In FIG. 4, a plurality of wires 24 are engaged by a connector 16 that further includes an equal plurality of metal tubes 42. Each tube 42 is configured to receive and therefore presents a congruent cross-section with a respective wire 24. In the illustrated embodiments, the tubes 42 and wires 24 are cylindrical in shape, however, it is appreciated that other (e.g., polygonal, ellipsoidal, etc.) cross-sections may be utilized. The outside diameter of the wire 24 and inside diameter of the tube 42 is cooperatively configured such that the wire 24 slidingly engages the tube 42. The individual tubes 42 each define a length sufficient to be inserted within the space 34 defined by the crimp 26 (as used hereinafter the term “crimp 26” shall be understood to alternatively include a tube 36 or other like connectors 16), and more preferably form fore and aft overlapping regions 44,46.

In operation, when the outer wall 38 of the crimp 26 is compressed, they engage the individual tubes 42, which are caused to also flatten and compress the wires 24. Increased frictional hold strength results between the tubes 42 and the connector 16 due to the greater surface area of engagement and a higher static friction provided in part by the individual tube material in comparison to the wire 24. It is appreciated that a small degree of metallurgical bonding also results from compressing the outer and individual tube materials together. As shown in FIG. 4a, the fore regions 44 of the tubes 42 and wires 24 may be bent back towards the centroid of the assembly 14, so as to form catches with the outer wall 38. It is also appreciated that a bar (not shown) can be placed near the bending area to reduce stress concentration. As an alternative, part or all of the regions 44 can be slide into the inner space 34 before the outer wall 38 is flattened. Finally, and as shown in FIG. 4, the individual tubes 42 can be made of electrically non-conductive material such that connector 36 can be electrically isolated from the structure members 12.

In FIG. 5, metal shims 48 replace the individual tubes 42. More particularly, two planar metal sections 48 sandwich the wires 24 and are inserted within the space 34. Like the tubes 42, the shims 48 are configured to extend through the space 34 and present overlapping regions. More preferably the shims 48 define recesses 48a (FIG. 5a) that are cooperatively configured along with the wires 24, so that the wires 24 are laterally secured when sandwiched in between the shims 48. This ensures full contact and distribution of the compressive force during crimping. Once positioned, the crimp 26 is compressed tightly, further causing the shims 48 to compress the wires 24. Finally, it is appreciated that the shims 48 can be made of electrically non-conductive material such that connector 36 is electrically isolated from the structure members 12.

In another embodiment shown in FIG. 6, a plurality of n wires 24 run from left to right and are bent over at both ends. The through spans 50 are then aligned with the bent over portions 52 of the wires 24 and axis-symmetrically crimped, so as to compress a plurality of 2n wire segments and form ellipsoidal loops 54 at the ends. In this configuration, the wire loops 54 form the fastening sections 28 of the assembly 14. Alternatively, the loops 54 can be eliminated or minimized to reduce material cost and the crimp 26 can fit into a slot (not shown) of a structure as an anchoring place.

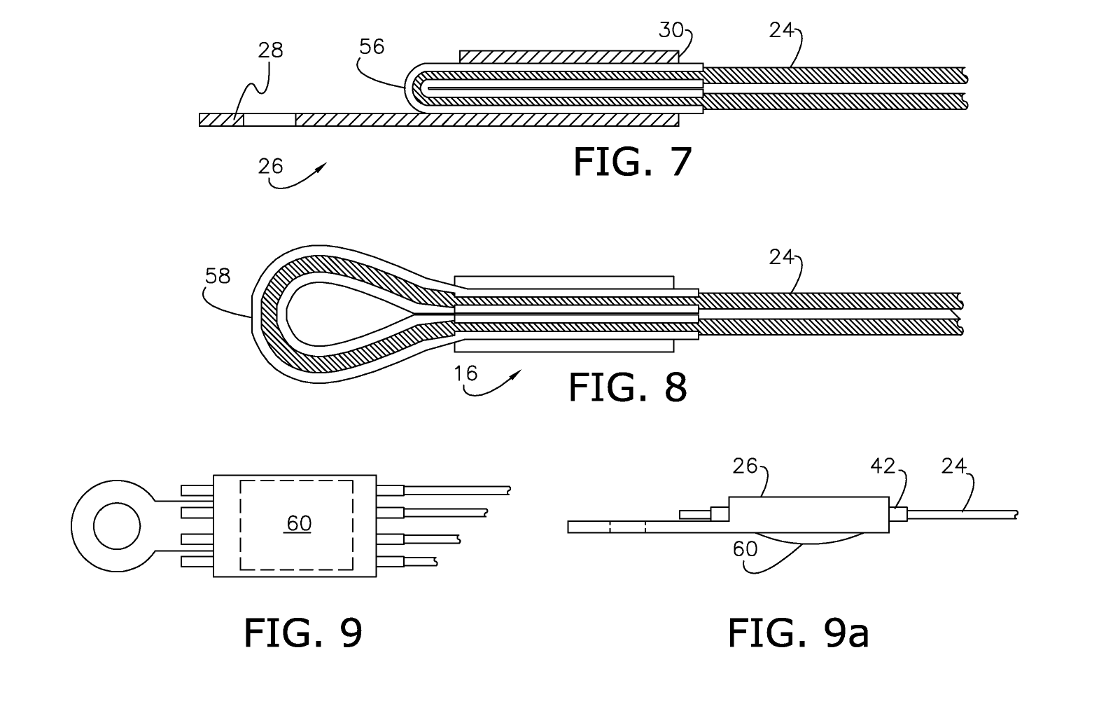

In FIG. 7, a plurality of wires 24 are fed into an elongated interior metal tube 56. The tube 56 and inserted wires 24 are then flattened and folded-over preferably at the longitudinal middle of the tube 56. Next, a ring terminal crimp 26 is slid over the bent interior tube 56 and axis-symmetrically crimped or flattened as shown. It is appreciated that the wires 24 may be inserted within the interior tube 56 in the same or opposing directions.

FIG. 8 shows a variation of the embodiment shown in FIG. 7, wherein a middle section 58 of the tube 56 is not flattened, and therefore not inserted within the crimp 26. The section 58 forms a loop that can be fastened to a bolt or bar.

Other variants can be derived from this general concept as well. For example, it is appreciated that a single wire 24 looping through a pair of metal tubes 56. The wires 24 can be joined at the bent point or other locations using a conventional method of joining, such as welding. Alternatively, it is appreciated that the external ring terminal crimp 26 may be omitted, where an interior tube is flattened and bent; for example, at least one wire 24 may be received by opposite tubes 56 (FIG. 7).

The interior metal tubes 56 and/or crimp 26 may be formed of insulative materials so that the wires 24 are electrically isolated from the crimp 26. The lead wires 22 connecting to electrodes can also be crimped together with the wires 24 within the flattened metal tube 56 or inserted into the crimp 26 and flattened. The wires 24 may run continuously or discontinuously.

It is also within the ambit of the present invention to increase friction by introducing longitudinal waves in the wire 24. For example, FIG. 9 shows the assembly shown in FIG. 4, wherein a downward grove or concavity 60 is formed within the outer wall 38 of the crimp 26. As the connector 16 is compressed the wires 24 are forced to enter and adopt the configuration of the concavity 60 thereby forming a sinuous configuration (FIG. 9a). Likewise, bowed or wavy profiled shims 48 may also be used to bend the configuration of the compressed wires 24 and produce the same affect. In this configuration, the outer wall 38 or shims 48 are preferably formed of stiffer material in comparison the remainder of the connector 16.

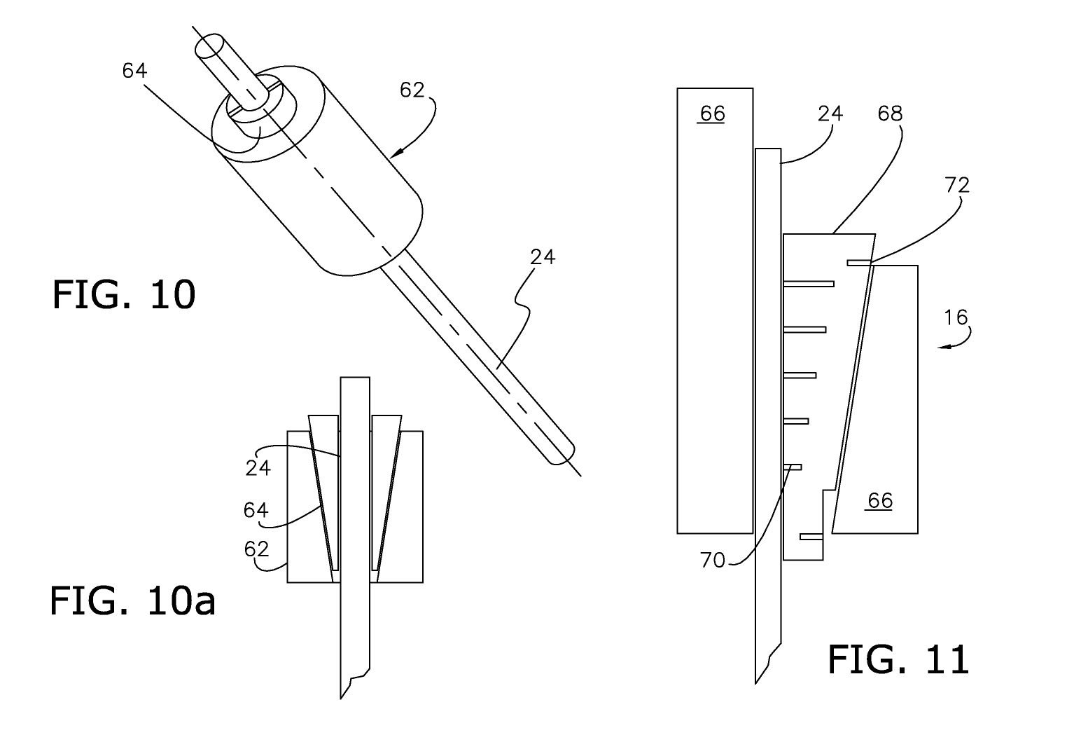

In a preferred embodiment, the connector 16 is configured to provide self-locking capabilities, wherein increased tensile load within the wire 24 results in a greater hold force being applied. FIG. 10, for example, shows a stiff collet 62 defining a sloped inner surface and having translating therein two half cones 64 of a softer material. The cones 64 define a through-hole/groove on their flat surfaces wherein the wire 24 extends. The wire 24 spaces the cones 64 so as to be sandwiched thereby, and force them into the collet 62. When a tensile load is applied to the wire 24 frictional force between the cones 64, wire 24, and collet 62 effectively form a grip (FIG. 10). As the load is increased, the friction between the wire 24 and the half-cones 64 will cause the grip to increase, potentially eliminating any issues with crimp loosening.

In FIG. 11, a similar self-locking configuration is represented, that better accommodates a plurality of wires 24. The wires 24 are placed in an outer housing 66 made from a first material and then a single triangular wedge 68 of material softer than the first is forced into the space 34. The coefficient of friction and wedge angle are selected to cause the wedges to lock. Again, it is appreciated that loading the wires 24 enhances the gripping force; however, this locking is dependent on both the friction and the rigidity of the supports. More preferably, the housing 66 and wedge 68 are modified so as to provide a more uniform gripping stress, mitigate stress concentration at the grips, and result in positive locking, thereby preventing loosening of the connection or overload on the wire 24. For example, the inner wedge 68 preferably defines slots 70 so as to provide near uniform distribution of the gripping force over the length of the grip. One or two locking rings/slots 72 are preferably defined to provide single or bi-directional locking and overload protection.

It is appreciated that a variation in the coefficient of friction (e.g., due to exposure to oil, water, etc.) and finite flexibility of the housing 66 may lead to loosening of the grip especially when the wire 24 is repeatedly cycled, so as to lead to repeated variations in the wire tension. The finite stiffness of the housing 66 implies that the clamping stress on the wires 24 varies along the engaging surface defined by the wire 24 and wedge 68; it is highest at the base of housing 66, where housing 66 is the stiffest, and lowest near the top of housing 66, where the stiffness of housing 66 is least. This leads to a stress concentration at the base of housing 66. Finally, it is noted that the non-positive locking provided by the wedge 68, may cause non-repeatability in the end positions of the wire 24 as it is cycled. These concerns are addressed in the slotted wedge-action grip shown in FIG. 11, without increasing the complexity of the grip significantly.

The slots allow the wedge 68 to flex as it is driven downward. The width, length and spacing of the slots can be selected to ensure generally uniform clamping pressure on the wire 24 at the engagement surface for the anticipatory pressure distribution obtained on the wedge surface when the wedge 68 is pushed into housing 66. One or more slots 72 corresponding to different wire diameters or limit loads in an application may be provided at the top and base of housing 66 to provide a positive restraint against overload on the wire 24 and to ensure repeatability of the wire end-position when used in conjunction with locking rings (not shown). Finally, it is appreciated through-out the embodiments that all exterior corners/edges are preferably rounded or otherwise relieved.

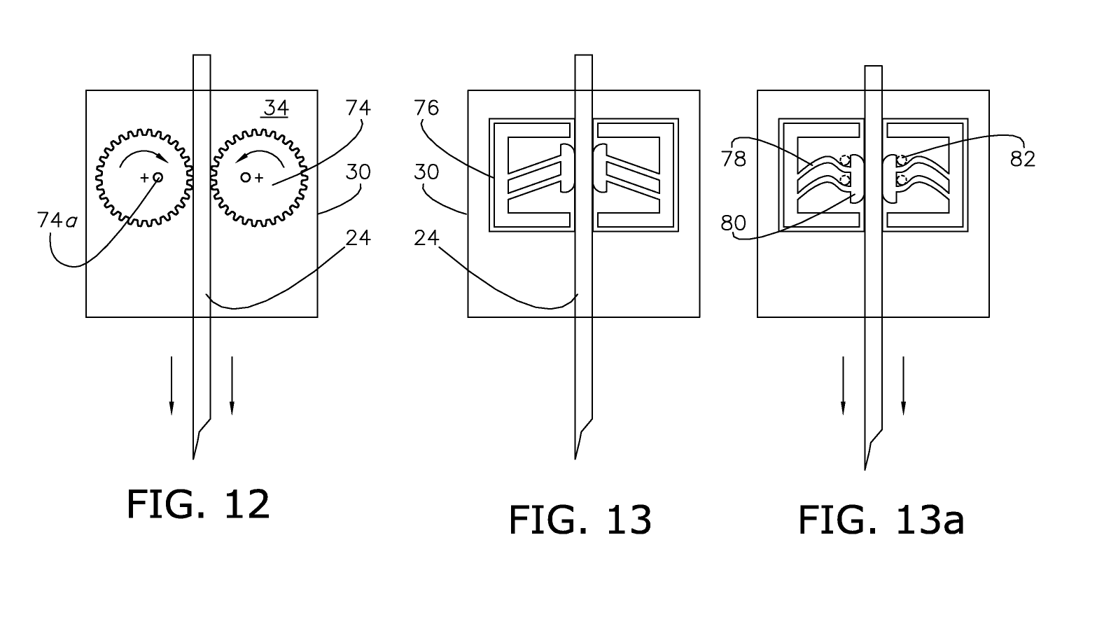

In another embodiment, a pair of off-centered identical gears (or cams) 74 provides a self-locking mechanism (FIG. 12), and is particularly applicable where only a single use is expected. More particularly, first and second uni-directional gears 74 are positioned within the space 34 defined by the crimp 26, housing 66 or other casing, such that a gap is presented between the gears. The wire 24 is placed within the gap, and the gap and wire 24 are cooperatively configured such that the wire engages both sets of gear teeth. The center of the gears 74 are spaced from their actual pivot points 74a (FIG. 12), such that as the wire 24 is pulled in the direction of motion the gears 74 are caused to increasingly press against the wire 24.

It is appreciated that the more force applied to the wire 24, the greater the normal pressure applied by the teeth against the wire 24, and that the pressure, teeth design and roughness of the wire 24 cooperatively determine the holding strength of the gears 74. It is also appreciated that the gears 74 must be driven over center in order to maintain the lock after a tensile load is ceased; else the wire 24 will be released when the force is released. Finally, the gears 74 may be the primary mechanism or can also serve as a backup grip.

Yet another embodiment is illustrated in FIGS. 13 and 13a, and configured to provide uniform gripping stress to mitigate stress concentration at the grips, positive one-way locking to prevent loosening of the connection, and scalability/ease of manufacture in comparison to the self-locking off-center gears 74. In this configuration, an inner frame 76 is preferably stamped out of a single sheet (e.g of steel), and presents a parallelogram linkage having flexible arms 78 and a clamping shoe 80 defined at the ends of the arms 78 (FIG. 13). The inner frame 76 is encased in the outer crimp 26. The thickness of the frame 76 may be smaller than, equal to, or larger than the diameter of the wire 24 to be joined; accordingly the wire 24 may be clamped on only two opposing faces covered by the shoe 80 or on the two opposing faces that are orthogonal to the shoe 80 as well.

In operation, feeding the wire 24 top-down into the crimp 26 causes it to engage the shoe 80. As the wire 24 is pulled through, the oppositely engaging shoes 80 grab the wire 24 and the arms 78 are caused to deflect by the force on the shoes 80, which ensures a generally uniform stress distribution. The geometry of arms 78 and the shape of shoes 80 are selected to minimize stress concentration in the clamped wire 24.

Once the wire 24 has been grasped with the desired force, dimples 82 are embossed in the crimp 26 such that they protrude into the frame 76 area and provide positive constraint that holds the arms 78 in the final position. Depending on the desired limiting force in the application and/or the wire diameter the location of dimples 82 relative to frame 76 may be varied. This provides a one-way restraint against joint loosening. Thus, if the wire 24 experiences higher forces, the clamping force will also increase. Alternatively, other geometry may be presented by the arms 78 that causes the clamping force to be reduced or even saturate towards a limiting value that prevents damaging the wire in the joint, if the force in the wire increases beyond a set limit.

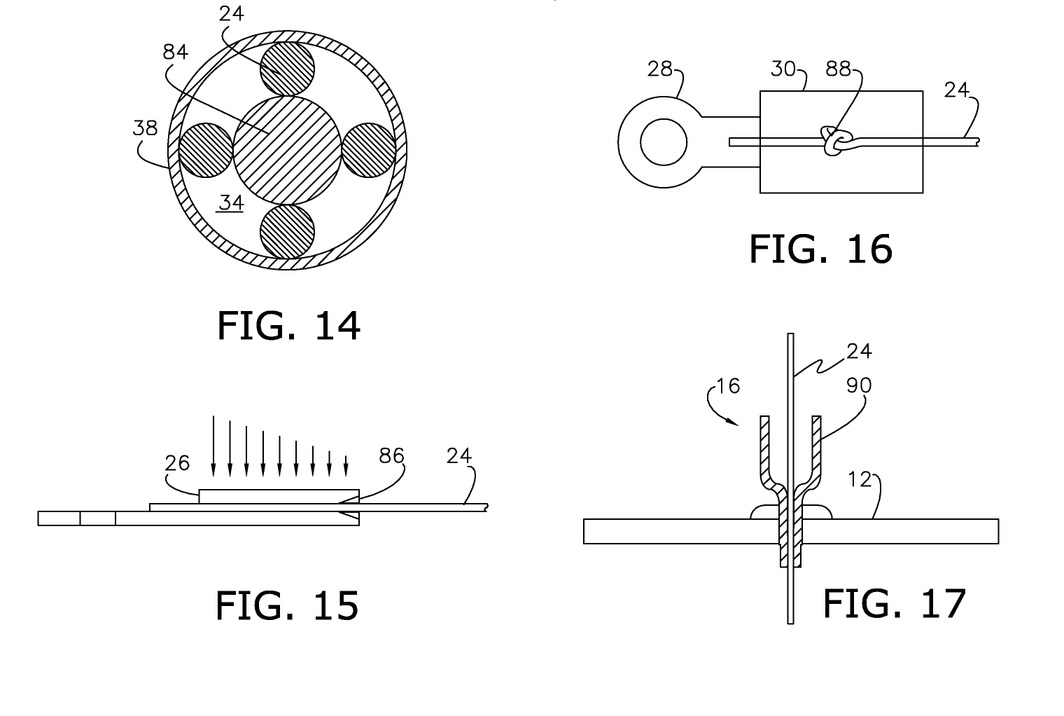

Other methods of reinforcing structural capacity of active material assemblies 14 include wrapping bare shape memory wires 24 or shape memory wires 24 in thin metal tubes together using a hose fastener, or through mechanical bending, and using shrink fitting and variable crimping strength along the length of the wire 24. With respect to shrink fitting, for example, FIG. 14 shows a cross-section of a connector 16 comprising a metal rod/block 84 that is cooled to a low temperature and pushed into a crimp 26 made of a metal having a lower thermal expansion coefficient than the rod 84. A plurality of wires 24 are deposed within the space 34 around the rod/block circumference or at one side. The crimp 26 can have a slightly large diameter than or be flattened to touch the rod 84. When the inner rod 84 is brought back to ambient temperature, a tight fit will be established.

In some cases it can be advantageous for the tightness of the crimp 26 to vary over its length (FIG. 15). In this configuration, the compressive strength is preferably weakest at the exit point of the wire 24 in order to minimize localized gradients in both stress and strain in the wire 24.

Another selectively advantageous approach is to have the end attachment fixed to the structure 10. In this case, however, any misalignment of the attachment with respect to the orientation of the wire/direction of the actuation force will lead to a kinking of/stress concentration in the wire 24 as it exits from the connector 16. Here, it is appreciated that providing a compliant element 86 (FIG. 15), such as a radius at the exit point, and/or compliant material at the interface between wire 24 and connector 16 will help alleviate this condition.

As shown in FIG. 16, to further improve the friction/hold strength between wire 24 and crimp 26 the contact area of engagement is preferably increased by tying a knot 88 or loop (not shown) in the wire 24, looping the wire 24 around a bar (also not shown), or as previously mentioned creating a wave form in the wire 24. Hold strength may also be improved by pre-conditioning the wire 24, such as through chemical-electrical processing.

Lastly, FIG. 17 depicts a shape memory wire 24 attached to a crimped ferrule 90 or flattened tube 36. The ferrule 90 is able to adjust its position along the longitudinal direction such that after soldering or welding the wire 24 can be facilely tightened.

This invention has been described with reference to exemplary embodiments; it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment disclosed as the best mode contemplated for carrying out this invention, but that the invention will include all embodiments falling within the scope of the appended claims.

What is claimed is:

1. An active assembly adapted for use in a structure including at least one structural member, for sustaining a load over a predetermined period, and for selectively effecting a change, said assembly comprising:
at least one element formed at least in part of an active material, such that the element is operable to reconfigure or produce a bias variance in the structure, in response to an activation signal; and
at least one connector fixedly secured to the element, and presenting an fastening section configured to enable interconnection between the active assembly and said at least one member,
said at least one element and connector being cooperatively configured to sustain the load over the period.

2. The assembly as claimed in claim 1, wherein the element presents at least one wire and the material is selected from the group consisting of shape memory alloy, shape memory ceramic, or shape memory polymer.

3. The assembly as claimed in claim 2, wherein each of said at least one wire defines a first wire end, and the connector is defined in part by a wall forming an interior space, the end is inserted within the space, and the wall is flattened such that the ends are intermediately compressed by the wall and the wall exerts a holding force upon the wire greater than the load.

4. The assembly as claimed in claim 3, wherein a portion of each wire adjacent the end is sandwiched between metal shims, before the ends are inserted within the space, and the wall and shims are flattened.

5. The assembly as claimed in claim 3, wherein each wire is inserted within individual tubes, the wires and tubes are inserted within the space, and the wall, tubes and wires are flattened.

6. The assembly as claimed in claim 5, wherein portions of the individual tubes and wires adjacent the end are passed through the space and bent back over the wall, so as to form catches therewith.

7. The assembly as claimed in claim 6, wherein a plurality of n wires define first and second ends, the first and second ends are passed through first and second connectors, such that a plurality of 2n wire segments extend within each connector, and bent back over the wall defined by the adjacent connector, so as to form catches therewith, and the wires form opposite ellipsoidal loops.

8. The assembly as claimed in claim 5, wherein the tubes are formed of electrically isolative material.

9. The assembly as claimed in claim 1, wherein the connector includes an interior tube and a ring terminal crimp presenting a wall defining an interior space, said at least one active material element includes a plurality of wires, a portion of each wire is passed through the interior tube, the interior tube is flattened and folded-over, and the crimp is slid over the interior tube and crimped.

10. The assembly as claimed in claim 1, wherein the connector includes first and second metal tubes each defining first and second tube ends, said at least one active material element includes at least one wire, a portion of each wire is passed through the first tube, portions of the first tube adjacent the ends are flattened, so as to present an unflattened intermediate tube portion, the first tube is bent over so as to adjacently position the flattened first tube portions, and the second tube is slid over the adjacent flattened first tube portions and is crimped, so as to compress and impart a holding force to the flattened first tube portions.

11. The assembly as claimed in claim 1, wherein the connector presents a self-locking mechanism including a collet defining an opening and at least one wedge positioned within the opening, said collet and wedge further defining a through-hole, said at least one element includes a shape memory wire, and at least a portion of which is passed through the through-hole and engages said at least one wedge, such that tensile force within the wire causes said at least one wedge to proportionally engage the wire and collet.

12. The assembly as claimed in claim 1, wherein the connector includes a pair of single-directional gears, said at least one element includes a shape memory wire, the gears are inter-positioned so as to define an intermediate gap wherein the wire is extendable, and the gears are off-centered so as to be caused to increasingly reduce the gap and compress the wire, as the wire is passed through the gap.

13. The assembly as claimed in claim 1, wherein the connector includes an external crimp defining an interior space, and a frame defining at least one flexible arm and a contact shoe attached to said at least one arm securely housed within the space, said at least one element includes a shape memory wire extending within the space, the frame is positioned adjacent the wire, such that the shoe is caused to increasingly engage and compress the wire as the wire is pulled through the space.

14. The assembly as claimed in claim 1, wherein a plurality of shape memory wires are tightly wrapped together using a hose fastener or mechanical bending.

15. The assembly as claimed in claim 1, wherein the connector includes a rod and a tube defining a space and having a lower thermal expansion coefficient than the rod, said at least one element includes at least one shape memory wire extending within the space, the rod is cooled, so as to be shrunk and enabled to be positioned within the space adjacent said at least one wire, and then allowed to warm, so as to expand and increasingly compress said at least one wire against the connector.

16. The assembly as claimed in claim 1, wherein said at least one element includes at least one shape memory wire, and the connector includes at least one ferrule configured to adjustably engage the wire.

17. The assembly as claimed in claim 1, wherein the element is a shape memory wire, the connector and wire cooperatively define a hold strength, and the hold strength is increased by forming a knot in the wire, forming a loop with the wire, forming a wave in the wire, utilizing chemical-electrical processing, or roughening the wire surface.

18. An active assembly adapted for use as a link in a structure including at least one structural member, for sustaining a load over a predetermined period, and selectively effecting a change in the structure, said assembly comprising:
at least one element formed at least in part of an active material operable to change a first condition in response to an activation signal; and
at least one connector fixedly secured to the element, presenting a fastening section configured to enable interconnection between the active assembly and said at least one member,
said at least one element and connector being cooperatively configured to sustain the load over the period, wherein said at least one element includes a shape memory wire, the connector includes a crimp defining a first end, configured to longitudinally apply a variable holding force to the wire, and presenting a compliant element at the end, so as to relieve stress concentrations in the wire near the end.

19. The assembly as claimed in claim 18, wherein the compliant element is a radial joint adjacent the wire and rotatably coupled to the crimp.

20. The assembly as claimed in claim 18, wherein the compliant element includes a layer of soft or flexible material adjacent the wire.
